(19) United States
(12) Patent Application Publication
(10) Pub. No.: US 2017/0306925 A1
(43) Pub. Date: Oct. 26, 2017

(54) THREE-VANE DOUBLE ROTOR FOR VERTICAL AXIS TURBINE

(71) Applicants: Ana Elisa RUBIO, (US); Humberto Antonio RUBIO, (US)

(72) Inventor: Humberto Antonio RUBIO, Buenos Aires (AR)

(21) Appl. No.: 15/507,335

(22) PCT Filed: Aug. 25, 2015
(86) PCT No.: PCT/IB2015/056434

§ 371 Date: Feb. 28, 2017

(30) Foreign Application Priority Data
Aug. 29, 2014 (AR) P20140103235

(51) Int. Cl. F03D 3/06; F03D 3/00; F03D 3/02

(52) U.S. Cl. CPC F03D 3/062; F03D 3/02; F03D 3/005; F05D 2250/712; F05D 2250/711

(57) ABSTRACT

A double rotor for vertical axis turbine includes two single three-vane rotors separated by a horizontal or separation plate, wherein such plate provides two different access areas to the propelling fluid, wherein between each of the three vanes of each of the single rotors it is determined surface continuity attenuated by curves in the fluid flow direction preventing parasitic flows during rotation thereof.

### FIELD OF THE INVENTION

This invention is included in the field of devices for vertical axis turbines driven by propelling fluids such as wind or liquids, including water.

### PURPOSE OF THE INVENTION

This invention is related to a double rotor that comprises two three-vane single rotors for vertical axis turbines.

### BACKGROUND OF THE INVENTION

U.S. Pat. No. 4,359,311 is related to a turbine device to use the kinetic energy of air or fluid movement; this patent shows a rotor mounted for rotation around a central axis including a plurality of means to turn the rotational movement into usable energy. The rotor includes a plurality of blades symmetrically arranged around a central axis, each blade has an inner edge and an outer edge; an important difference with respect to the rotor of this invention is that the rotor is double and the blades are joined, thus forming a single body.

U.S. Pat. No. 4,362,470 is related to a wind turbine that has a rotating column around an axis, and a plurality of blades arranged on the column and adapted to rotate by wind, thus allowing the axis to rotate, and each blade has an outer portion that has an outer edge formed on the external end of a radius centered on the axis of the column and extending rearward from the outer edge above a described circumference from the center, and each one of the blades has an inner edge counteracting backward with respect to the outer edge in a direction that is normal to the radius. In this invention the rotor blades are joined thus forming a single unit.

U.S. Pat. No. 4,926,061 is related to windmill with two designs, both aesthetically acceptable and able to operate without noise pollution, it has a rotating vertical axis with three or four wind traps consisting of a pair of concave vanes. These vanes are both joined by welding to a base and an upper plate, thus forming a unit to catch wind. Each vane is positioned 60 degrees away from the next one in the first design and 45 degrees in the second design.

This patent is related to a design forming a double rotor but it is different from the rotor of this invention, since rotor blades of this invention are joined forming a single unit while the patent 4,926,061 does not.

U.S. Pat. No. 5,333,996 is related to a fluid rotor for rotating electric generators or other mechanical equipment. The fluid rotor contains multiple curved blades which are in the same rotating plan and which are spaced so closely as to maximize the efficiency of fluid catching. Open blades are designed to overlap each other so that there are always two blades positioned in such a way so as to catch fluids. It is indicated that more than one rotor can be used simultaneously; the rotor of this patent differs from the rotor of this invention with respect to the fact that the rotor blades of this invention are joined forming a single unit while in this patent the blades comprise multiple separations between them, thus decreasing their efficiency.

U.S. Pat. No. 5,463,257 is related to a wind power machine or to produce a job by wind power. It is indicated that the wind power machine is more efficient in its rotating operation and it can be used for power generation, water pumping and any other application that takes advantage of wind. It comprises a three-bladed rotor having an outer curved surface and an inner flat surface on each blade; rotor is not formed as a single unit as it happens on this invention.

U.S. Pat. No. 5,664,418 is related to a vertical axis wind turbine supported by a support frame in the place, the presence of a rotor with vertical axis and an outer rotor circumferential edge and blades with vertical surfaces thereof to receive wind are indicated; such vertical surfaces of blades extend from the outer rotor circumferential edge inwardly to form part of a vane cavity which prevents air from entering the central part of the turbine; rotor blades described in such patent. The bonding surface between rotor blades of such patent does not show an attenuated continuity through curves between two adjacent vanes such as the rotor of this invention.

U.S. Pat. No. 6,015,258 is related to a wind turbine device to turn wind power into electric power. The device includes a central rotating axis, a plurality of rotor blades joined to the central axis, and a plurality of convex fins spaced around the proximity of rotor blades. It is indicated that the relation between the number of rotor blades and the number of fins is at least 1.25 to 1. The rotor described in such patent includes a plurality of blades which are positioned radially outward from the central axis, each blade, preferably of the same size, is equidistantly spaced around the central axis; due to its configuration, the rotor of such patent always supports an even number of blades, thus being extremely different from the one of this invention.

U.S. Pat. No. 6,465,899 is related to an omnidirectional vertical axis turbine which includes a rotor stator combination that maximizes power production by increasing wind speed and pressure; some options of the invention comprise superposed rotors. The rotors of such patent comprise spaced equidistant curved surfaces that do not show an attenuated continuity through curves between them, such as the rotor of this invention.

U.S. Pat. No. 6,666,650 is related to a power installation produced by wind based on the principle of passing flow comprising a multiplant vertical rotor having three blades on each plant for power generation operating according to this principle. The multiplant rotor is mounted on a frame and configured to move counterclockwise around an axis and it comprises three aerodynamically shaped wings on each plant. These wings do not form a single unit; therefore, the device on such patent is different from the rotor of this invention.

U.S. Pat. No. 6,948,905 is related to a horizontal wind generator comprising a windmill coupled to a power generator. The windmill includes a vertical axis mounted for rotation in the base with a plurality of wind collecting units mounted in spaced opposition along axial locations along the vertical axis, two units per plant, the wind collecting units located at the ends of a horizontal axis with respect to the vertical axis are displaced in order to collect wind more efficiently. The two-wind collecting unit per plant is very different from the rotor mentioned on this invention wherein it has three blades per plant and it also shows an attenuated continuity through curves between two adjacent blades.

U.S. Pat. No. 7,008,171 represents a modification of the Savonius rotor used in a wind turbine that provides a drainage channel in each blade. Devices of three plants with two blades per plant are shown. The blade of the modified Savonius rotor of this patent has “S” shape which is very different to the proposed rotor of this invention wherein it has three blades per plant showing an attenuated continuity trough curves between two adjacent blades thereof.

U.S. Pat. No. 7,220,107 is related to a windmill that rotated due to wind power to efficiently obtain rotational energy regardless of the wind direction; it operates through a rotor having three curved vane type walls differentiating from this invention with respect to the fact that vanes are not joined together and they do not have three blades per plant thus achieving an attenuated continuity through curves between two adjacent vanes thereof.

U.S. Pat. No. 7,314,346 is related to a three-blade Savonius rotor for vertical axis wind turbines having higher features than conventional three-blade reactors arranged in three plants; the center of such rotor to which the three vanes are joined shows circular surfaces that abruptly end against such vanes; this does not generate an attenuated surface continuity through curves but projections that produce turbulences that decrease the rotor performance.

U.S. Pat. No. 7,896,608 is related to a wind turbine with three-vane slow rotor, this patent provides three plants including displaced vane rotors, the vanes are not connected in a single unit and they do not have attenuated continuity through curves between two adjacent rotor vanes on each plant as the rotor of this invention.

U.S. Pat. No. 8,322,992 shows a method for building a device with blades to use in a modular current generator driven by wind. In such patent, each module comprises a rotor having more than three blades wherein each blade is displaced 90 degrees with respect to the one above and below it. Rotor blades are not connected in a single unit and they do not have attenuated continuity through curves between two adjacent rotor blades on each floor as the rotor of this invention.

### SUMMARY OF THE INVENTION

This invention comprises a double rotor for vertical axis turbine including two three-vane single rotors separated by a horizontal or separation plate, wherein such plate provides two separate access areas for propelling fluid wherein between each one of the three vanes of each single rotor, it is determined continuity of the surface which is attenuated by curves, in the direction of fluid flow, preventing parasitic flows during rotation thereof. In such double rotor, the three-vane single rotors comprise the upper and lower rotor according to their relative spatial positions in such vertical axis turbine; each of the upper and lower rotors has hollow cores.

Hollow cores are covered below and above, leaving an opening which is passed by the vertical axis turbine which is attached to the upper and lower rotors.

In the double rotor of this invention, the upper rotor is separated from the lower rotor by means of the horizontal or separating plate which is attached to the upper and lower rotors, and which is also passed by the vertical axis turbine.

In such double rotor, both the upper and lower rotors have their vanes separated by means of an angle of 120 degrees, and each vane of the upper rotor is uneven with respect to each vane of the lower rotor at a 60-degree angle.

In the double rotor above mentioned, each one of the three vanes that make up the upper and lower rotors are arranged on the outer side of a R radius circumference around the vertical axis, having an inner wall, which forms the hollow core of each single rotor.

Within it, the farthest area from the vertical axis of each vane belonging to the upper and lower rotors, during rotation, produces a 4R radius circumference equals to the radius of the horizontal or separating plate which separates the upper rotor from the lower one.

Each of the vanes that make up the upper and lower rotors have dolphin fin shape, having a profile aerodynamically designed as a plane wing shape, wherein such profile has a convex area in the so-called extrados and a concave area in the so-called intrados.

In the double rotor of this invention, both on the upper and lower rotors, the convex area on the extrados of one of the vanes joins with the concave area of the intrados of the next vane by means of a 0.5 radius circumference portion.

In the double rotor above mentioned, the convex area of the extrados of each of the vanes corresponds to a 5R radius circumference portion taking as center the first point on the 4R radius circumference generated by the outermost portion of each vane in the rotation around the vertical axis and the concave area of the intrados of each of the vanes corresponds to a 4R radius circumference portion taking as a center the second point on the 4R radius circumference generated by the outermost portion of each vane in the rotation around the vertical axis.

The separation between the first point and the second point on the 4R radius circumference generated by the outermost portion of each vane in the rotation around the vertical axis is 1.20R.

### BRIEF DESCRIPTION OF THE DRAWINGS

In order to understand this description, the attached drawings show an example of embodiment, but not limited, of the object of this invention:

FIG. 1 shows two side views of the three-vane double rotor for a vertical axis turbine.

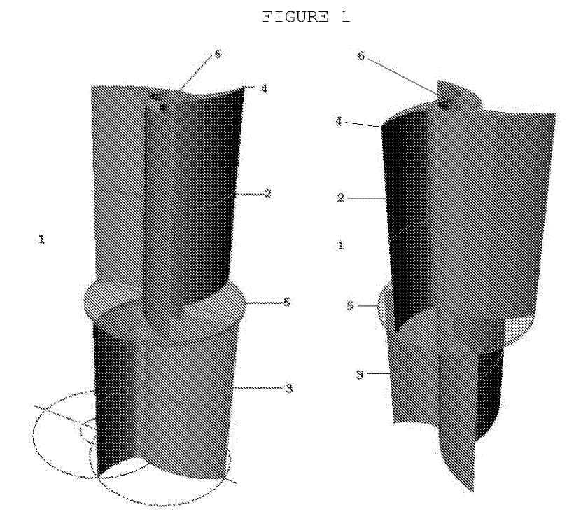

FIG. 2 shows two top side views of each single rotor that makes up the three-vane double rotor for a vertical axis turbine; in the top view, the hollow core is shown while in the bottom view such hollow core is covered and the hole for the insertion of the vertical axis turbine can also be seen.

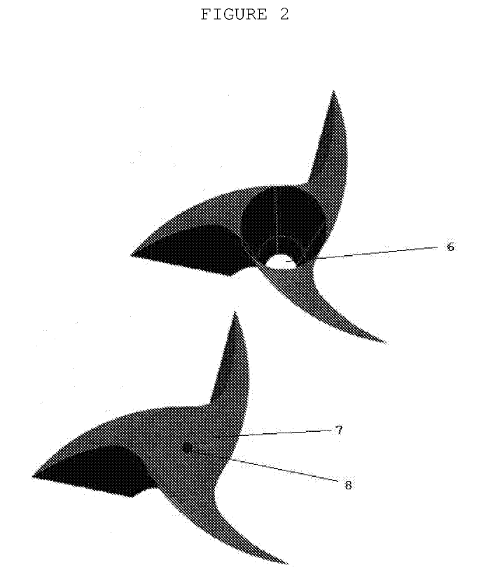

FIG. 3 shows a top view of each single rotor that makes up the three-vane double rotor for vertical axis turbine wherein the 120-degree separation between each vane is shown.

FIG. 4 shows a top view of the two single rotors that make up the three-vane double rotor for vertical axis turbine wherein the 60-degree separation between the vanes of the upper rotor and the ones of the lower rotor is shown.

FIG. 5 shows a top view of each single rotor that makes up the three-vane double rotor for vertical axis turbine wherein its dimensions with respect to the R radius are shown.

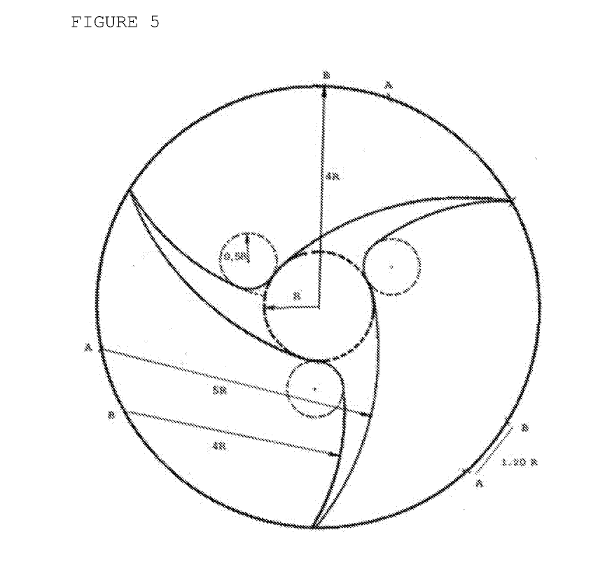

FIG. 6 shows two plain side views of the three-vane double rotor for vertical axis turbine.

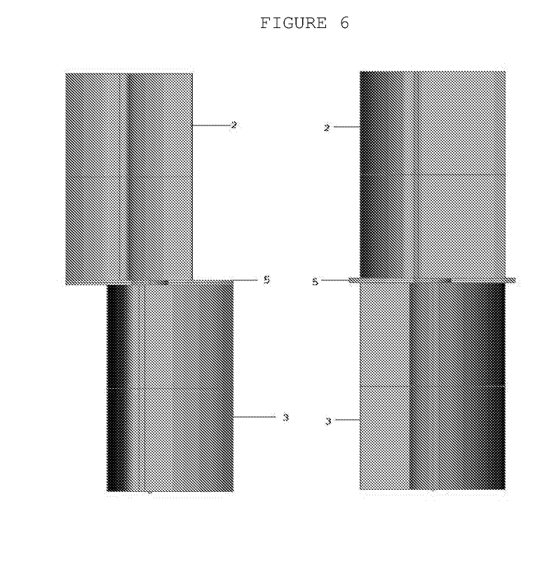

FIG. 7 shows on top the three types of rotors used in wind tunnel tests and at the bottom the layout of the model within the wind tunnel.

FIG. 8 shows a top view of each single rotor that makes up the three-vane double rotor for vertical axis turbine wherein the circumferences generated by the 4R, 0.5R and 1.2 R radius are shown.

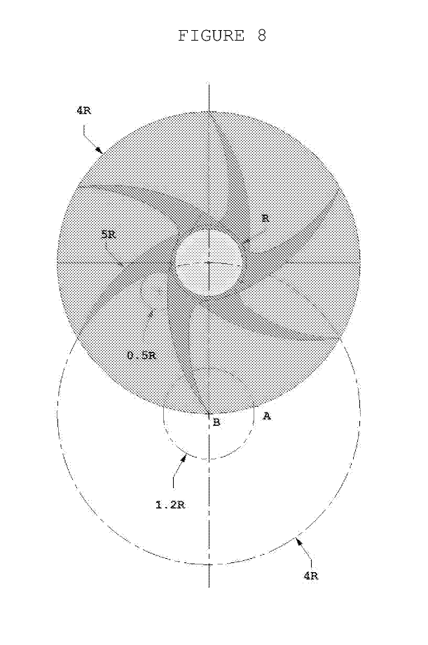

FIG. 9 shows a vane with R radius inner circumference and 5R radius circumference generated by the extrados, 4R radius circumference generated by the intrados, 1.2R radius circumference generated by the separation of points A and B on the 4R radius circumference and 0.5R radius circumference that joins the intrados of such vane with the extrados of the next one.

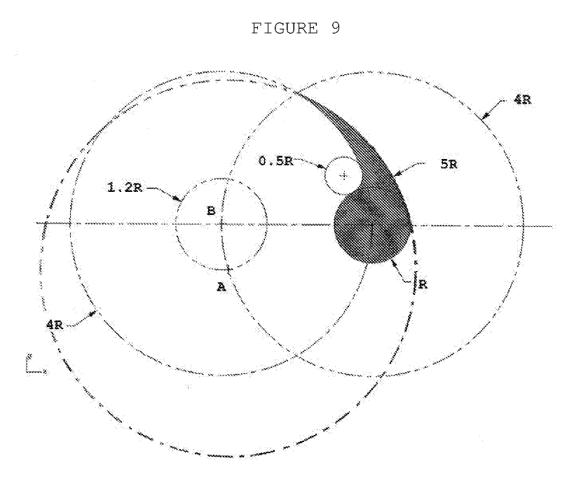

### DETAILED DESCRIPTION OF THE INVENTION

This invention is related to a three-vane (4) double rotor (1) for vertical axis turbine driven by propelling fluids such as wind or liquids, including water.

The double rotor of this invention comprises two three-vane single rotors, wherein one of the single rotors is called the upper rotor (2) and the other one is called the lower rotor (3) according to their relative spatial positions in such vertical axis turbine, the upper rotor is located in a position above the other single rotor, called lower rotor, both of them are separated by a horizontal or separation plate (5), wherein such plate (5) provides two different access areas for such propelling fluid. Both rotors, the upper rotor (2) and the lower rotor (3), that make up the double rotor (1) move together with the horizontal plate (5) around a vertical axis due to the action of the propelling fluid, such as wind or liquids, which in turn operates the vanes thereof.

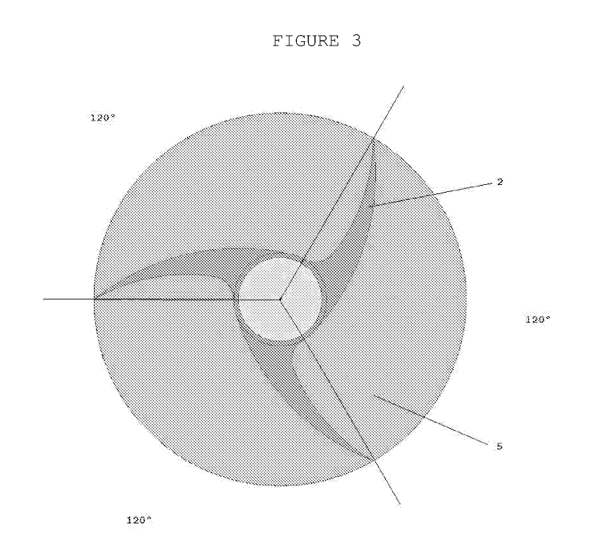

The vanes of each of the single rotors (upper rotor and lower rotor) that make up the double rotor are separated from each other at an angle of 120 degrees (FIG. 3).

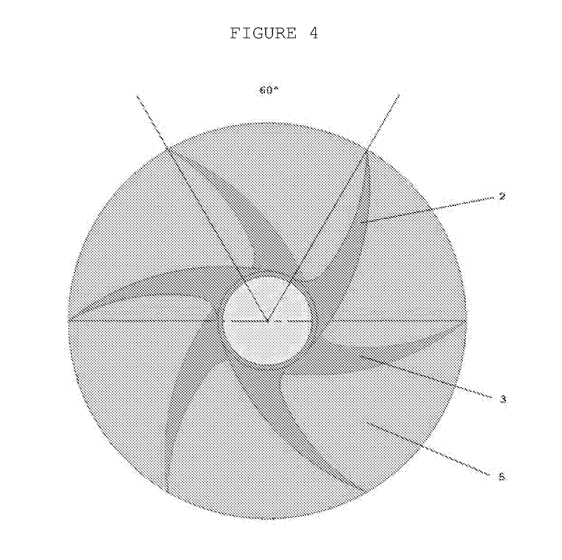

Each vane of the upper rotor (2) is displaced from the corresponding vanes on the lower rotor (3) at an angle of degrees (FIG. 4). This displacement optimizes the torque produced by a fluid stream and it also prevents cyclic vibrations when distributing propulsion along the whole rotor.

Each of the three vanes that make up each of the single rotors or the double rotor is situated in a R radius circumference around the vertical axis that produces the hollow core of each single rotor. These hollow cores of each single rotor are covered (7) above and below leaving an opening (8) in order that the vertical axis passes so that the fluid does not enter into such hollow cores (6).

Each of the vanes (4) that make up the upper rotor (2) and the lower rotor (3) have dolphin fin shape, having a profile with aerodynamic design like a plane wing, wherein such profile has the so-called extrados and intrados.

The farthest area from the vertical axis of each vane (4) of each of the rotors (upper rotor and lower rotor) that make up the double rotor (1) generates, during rotation around the vertical axis, a 4R radius circumference.

Considering the aerodynamic profile of each vane that makes up each of the rotors (upper rotor and lower rotor), such as a plane wing, it has a convex area in the extrados and a concave area on the intrados.

On each rotor (upper rotor and lower rotor (2, 3)) the convex area in the extrados of one of the vanes is joined to the concave area in the intrados of the next vane across a portion of 0.5R radius circumference.

The convex area in the extrados of each of the vanes corresponds to a portion of 5R radius circumference taken at a point A on the 4R radius circumference generated by the outermost portion of each vane during rotation around the vertical axis.

The concave area in the intrados of each of the vanes corresponds to a portion of 4R radius circumference taken at a point B on the 4R radius circumference generated by the outermost portion of each vane during rotation around the vertical axis.

The separation between point A and point B for the same vane corresponds to a distance equal to 1.20R.

According to the above, the relations regarding sizes of each single three-vane rotor that makes up the double rotor (1) of this invention can be unambiguously defined based on a R constant corresponding to the radius of the central circumference of each of the single rotors; each of the three vanes of each of the single rotors is joined to such central circumference.

This central R radius circumference corresponds to the center of each rotor which is hollow (hollow core rotor (6)), which makes the structure lighter and the start easier due to the action of the fluid. This R radius circumference has an inner wall that makes the structure stronger; inside such structure it is located the so-called hollow core of each single rotor. Such hollow cores are covered below and above, leaving an opening for the vertical axis passing so that the fluid does not enter into such hollow cores (6).

This way, having defined each of the single rotors that make up the double rotor (1) of this invention, it is determined continuity of the attenuated surface through curves between each vane in the flow direction of the fluid, resulting in the easier start of the turbine, elimination of parasitic flows like vortices (parasitic flow stopping rotor movement) in the area near the rotor axis leading to a higher performance thereof; in addition, it makes easier fluid outflow and decreases turbine's noise where this double rotor is installed. This continuity of the attenuated surface through curves between each vane (4), in the direction of the propelling fluid inlet, is maximized for a three-vane rotor; the increase of vanes in rotors (more than three) produces no attenuated joining curves thus giving rise to tangential surfaces that increase noise and vibration when the turbine using them is in operation.

It is worth mentioning that on the configuration of the double rotor of this invention, the fluid (wind or liquid) that causes movement of such rotor always hits two vanes of a single rotor and one vane of the other single rotor separated by a horizontal or separation plate, simultaneously; this determines that three vanes will always be in optimum position or easily achieve such optimal position to start (two on one side of the horizontal or separation plate and the other on the other side) in the turbine where it is installed. If we consider a single three-vane rotor of this invention only, it will have at most two vanes facing the fluid (for example, wind or water) since the remaining vane shall be in opposite position; at the same time, due to the displacement of 60 degrees between the upper and lower vanes of each single rotor, a vane of the other single rotor will also be in position to receive the fluid. That is, three vanes (2+1) will always be in position for driving the turbine axis in the double rotor of this invention regarding such turbine that has a single three-vane rotor only. This means that the turbine using the double rotor of this invention has 50% more starting power than one that uses a single three-vane rotor, which implies a start with less fluid speed.

Among the materials used for the construction of the double rotor of this invention, the followings are preferred: metal, plastic, or wood, any material used in construction and their combination.

These materials may also be used in combination to construct the single rotors that make up the double rotor.

### Wind Tunnel Tests

Comparative tests of the rotor of this invention against other single and double rotors without continuity of the attenuated surface through curves between vanes were done.

The rotors used in each case had a diameter of 20 cm and a height of 0.5 m with hollow core. The turbine used in all tests had a height of 0.5 m and a diameter of 0.415 m.

In order to achieve the objective, the tests were conducted in a wind tunnel with a test section of 1.83 m×2.6 m×19 m and adjustable speed. Measurements were done with variable starting speeds, depending on the direction of the turbine with respect to the direction of wind, and maximum speed of 18 m/s. On each test, the following performance information of the turbine was obtained:

1. Free starting current speed (m/s).
2. Mechanical torque (Nmm) generated by the rotor.
3. Angular speed (rpm).

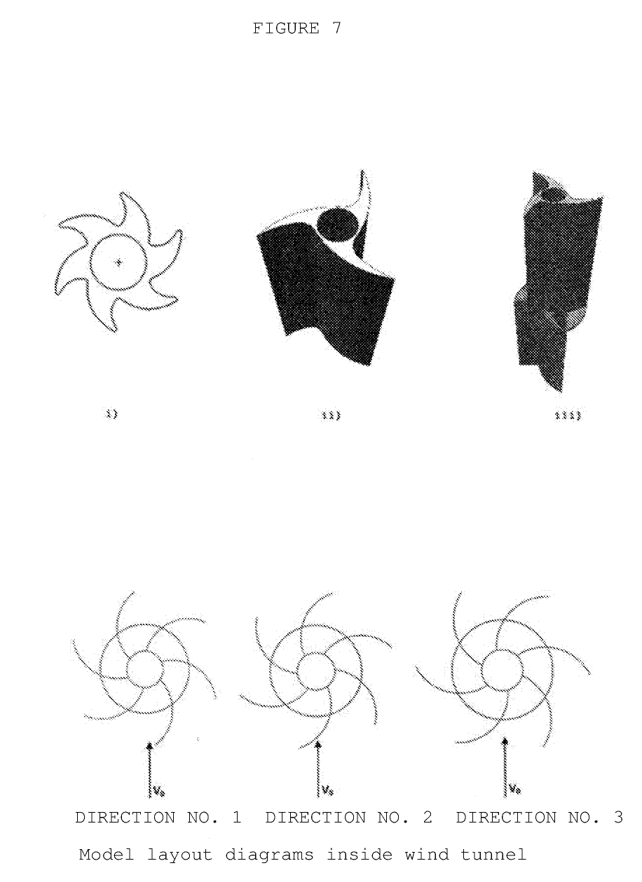

The three directions of the turbine are shown on top of FIG. 7, including the model layout diagrams inside the wind tunnel for each test; in the center of each direction, vanes to perform the tests are arranged.

### Equipment

a) Turbulent boundary layer wind tunnel, test section 1.83 m×2.6 m×19 m, adjustable speed.
b) Portable hot wire anemometer, TESTO 512.
c) Torque wrench RT2USB, AEP.

### d) Digital Tachometer, HEPTA.

### Methodology

### Test Preparation

a) Placement, alignment and leveling of the supporting structure the turbine.
b) Placement and leveling of torque wrench.
c) Placement of digital tachometer.

### Test Procedure

### Starting Speed Measurement

Start speeds in each case were determined; firstly, for the turbine without load, that is the axis free, and secondly, for the turbine with load, being the load the resistance to rotation exerted by the torque wrench on the rotor axis.

In the first case, turbine without load, angular speed measurements were performed using a HEPTA digital tachometer.

Measurement of torque and rotation speed (rpm)

Torque and rpm general procedure consisted in the measurement of speeds between 7 and 18 m/s. The first measured speed corresponds to the starting speed and it depends on each individual case on the direction of the turbine and on the fact of being load or not (if connected or not the torque wrench).

The above procedures were applied to the following rotors:

i) 6-blade single rotor (with vanes without surface continuity attenuated by curves)
ii) 3-blade single rotor (with vanes with surface continuity attenuated by curves)
iii) Double rotor comprising two 3-blades single rotors (vanes with surface continuity attenuated by curves corresponding to the rotor of this invention)

### Test Results

i) Test on 6-Blade Single Rotor (with Vanes without Surface Continuity Attenuated by Curves)

The formation of a six-blade rotor causes that joining surfaces between the vanes can not be attenuated by curves; the distribution of six vanes around the rotor center determines cutting surfaces that generate parasitic flows during rotation thereof (see upper FIGURE).

### Start Speed:

Start speeds obtained for the three directions of the wind are summarized in the following Table 1:

TABLE 1
start speeds (m/s), assisted or autonomous

| | |
|---|---|
| | With load of torque |
| Without load | wrench |

| Direction | Assisted | Autonomous | Assisted | Autonomous |
|---|---|---|---|---|
| of turbine | start | start | start | start |
| No. 1 | 10 | >18 | 10 | >18 |
| No. 2 | 7 | 18 | 7.5 | 12 |
| No. 3 | 7.5 | >18 | 7 | 18 |

### Angular Speeds for Each Direction:

Angular speeds obtained for the three directions of the wind are summarized in the following Tables 2, 3 and 4:

TABLE 2
RPM for direction No. 1

| | | Rotor with |
|---|---|---|
| Speed (m/s) | Free rotor | torque wrench |
| 10 | 20 | — |
| 11 | 29 | — |
| 12 | 38 | — |
| 13 | 48 | — |
| 14 | 60 | — |
| 15 | 90 | — |
| 16 | 140 | — |
| 17 | 210 | — |
| 18 | 320 | — |

TABLE 3
RPM for direction No. 2

| | | Rotor with |
|---|---|---|
| Speed (m/s) | Free rotor | torque wrench |
| 7 | 19 | — |
| 8 | 37 | — |
| 9 | 50 | — |
| 10 | 60 | — |
| 11 | 108 | — |
| 12 | 140 | — |
| 13 | 170 | — |
| 14 | 240 | — |
| 15 | 270 | — |
| 16 | 310 | — |
| 17 | 390 | — |
| 18 | 430 | — |

TABLE 4
RPM for direction No. 3

| | | Rotor with |
|---|---|---|
| Speed (m/s) | Free rotor | torque wrench |
| 7.5 | 19 | — |
| 8 | 27 | — |
| 9 | 37 | — |
| 10 | 51 | — |
| 11 | 68 | — |
| 12 | 79 | — |
| 13 | 110 | — |
| 14 | 150 | — |
| 15 | 205 | — |
| 16 | 360 | — |
| 17 | 400 | — |
| 18 | 470 | — |

### Torque:

It was done the measurement of torque for direction 3, wherein manual start under this condition reached 18 m/s. The results are summarized in Table 5:

TABLE 5
Torque (Nmm) for direction No. 3:

| Speed (m/s) | Rotor with torque wrench |
|---|---|
| 8 | — |
| 9 | — |
| 10 | — |
| 11 | — |
| 12 | — |
| 13 | — |
| 14 | — |
| 15 | — |
| 16 | — |
| 17 | — |
| 18 | 18 |

ii) Test on 3-Blade Single Rotor (with Vanes with Surface Continuity Attenuated by Curves)

A single three-blade rotor was used just like the one corresponding to each of the single rotors composing the upper rotor and the lower rotor of this invention; the height is the same.

### Start Speed:

Start speeds obtained for the three directions of the wind are summarized in Table 6:

TABLE 6
start speeds (m/s), assisted or autonomous

| | |
|---|---|
| | With load of torque |
| Without load | wrench |

| Direction | Assisted | Autonomous | Assisted | Autonomous |
|---|---|---|---|---|
| of turbine | start | start | start | start |
| No. 1 | 7 | >18 | 13 | >18 |
| No. 2 | 5.5 | 11 | 11 | 15 |
| No. 3 | 4.5 | 14.5 | 12 | >18 |

### Angular Speeds and Torque for Each Direction:

Angular speeds and torque obtained for the three directions of the wind are summarized in the following Tables 7, 8, 9, 10, 11 and 12:

Results for direction No. 1

TABLE 7
RPM for direction No. 1

| | | Rotor with |
|---|---|---|
| Speed (m/s) | Free rotor | torque wrench |
| 7 | 85 | — |
| 8 | 200 | — |
| 9 | 305 | — |
| 10 | 691 | — |
| 11 | 895 | — |
| 12 | 1010 | — |
| 13 | 1328 | 61 |
| 14 | 1494 | 123 |
| 15 | 2000 | 173 |
| 16 | — | 243 |
| 17 | — | 448 |
| 18 | — | 1268 |

TABLE 8
Torque (Nmm) for direction No. 1

| Speeds (m/s) | Rotor with torque wrench |
|---|---|
| 14 | 21.49 |
| 15 | 22.34 |
| 16 | 23.18 |
| 17 | 24.49 |
| 18 | 25.93 |

Results for direction No. 2

TABLE 9
RPM for direction No. 2

| | | Rotor with |
|---|---|---|
| Speed (m/s) | Free rotor | torque wrench |
| 5.5 | 100 | — |
| 6 | 185 | — |
| 7 | 275 | — |
| 8 | 370 | — |
| 9 | 630 | — |
| 10 | 830 | — |
| 11 | 975 | — |
| 12 | 1140 | 93 |
| 13 | 1310 | 115 |
| 14 | 1475 | 211 |
| 15 | 1595 | 267 |
| 16 | 1783 | 382 |
| 17 | — | 583 |
| 18 | — | 750 |

TABLE 10
Torque (Nmm) for direction No. 2

| Speeds (m/s) | Rotor with torque wrench |
|---|---|
| 12 | 16.52 |
| 13 | 17.35 |
| 14 | 18.89 |
| 15 | 20.04 |
| 16 | 21.93 |
| 17 | 25.04 |
| 18 | 27.70 |

Results for direction No. 3

TABLE 11
RPM for direction No. 3

| | | Rotor with |
|---|---|---|
| Speed (m/s) | Free rotor | torque wrench |
| 4.5 | 120 | — |
| 5.5 | 207 | — |
| 6 | 307 | — |
| 7 | 500 | — |
| 8 | 703 | — |
| 9 | 835 | — |
| 10 | 1065 | — |
| 11 | 1250 | — |
| 12 | 1430 | — |
| 13 | 1554 | 236 |
| 14 | 1930 | 409 |
| 15 | 2250 | 795 |
| 16 | 2500 | 982 |
| 17 | — | 1201 |
| 18 | — | |

TABLE 12
Torque (Nmm) for direction No. 3

| Speeds (m/s) | Rotor with torque wrench |
|---|---|
| 13 | 12.84 |
| 14 | 15.24 |
| 15 | 19.58 |
| 16 | 22.45 |
| 17 | 26.57 |
| 18 | 26.86 |

Based on the above results the following power curve was done. See the following table 13:

### Preliminary Conclusions:

The single three-blade rotor with vanes with surface continuity attenuated by curves has better performance than a single 6-blade rotor since it needs less wind speed in some assisted start configurations, being almost equal the behavior in autonomous start.

iii) Test on 3-Blade Double Rotor (Vanes with Surface Continuity Attenuated by Curves)

A three-blade double rotor, just like the model of this invention, was used.

Those skilled in the art will note the possibility of adding various modifications and variations to the invention without excluding the spirit or scope thereof. Angular speeds and torque for each direction: Angular speeds and torque obtained for the three directions of the wind, as well as the power curve, are summarized in

Tables 14, 15, 16, 17, 18, 19, 20 and 21:

TABLE 14
start speeds (m/s), assisted or autonomous

| | |
|---|---|
| | With load of torque |
| Without load | wrench |

| Direction | Assisted | Autonomous | Assisted | Autonomous |
|---|---|---|---|---|
| of turbine | start | start | start | start |
| No. 1 | 4 | 5 | 7 | 7 |
| No. 2 | 4 | 5 | 7 | 7 |
| No. 3 | 4 | 4 | 7 | 7 |

### Results for Direction No. 1

Angular Speeds (rpm)

TABLE 15
RPM for direction No. 1

| | | Rotor with |
|---|---|---|
| Speed (m/s) | Free rotor | torque wrench |
| 4 | 17 | — |
| 5 | 44 | — |
| 6 | 74 | — |
| 7 | 119 | 22 |
| 8 | 173 | 54 |
| 9 | 248 | 98 |
| 10 | 346 | 170 |
| 11 | 467 | 252 |
| 12 | 575 | 362 |
| 13 | 695 | 455 |
| 14 | 800 | 588 |
| 15 | 909 | 742 |
| 16 | 1025 | 830 |
| 17 | 1120 | 921 |
| 18 | 1240 | 1035 |

TABLE 16
Torque (Nmm) for direction No. 1

| Speeds (m/s) | Rotor with torque wrench |
|---|---|
| 7 | 18 |
| 8 | 19 |
| 9 | 19 |
| 10 | 20 |
| 11 | 21 |
| 12 | 21 |
| 13 | 22 |
| 14 | 23 |
| 15 | 24 |
| 16 | 25 |
| 17 | 26 |
| 18 | 27 |

Results for direction No. 2

Angular Speeds (rpm)

TABLE 17
RPM for direction No. 2

| | | Rotor with |
|---|---|---|
| Speed (m/s) | Free rotor | torque wrench |
| 4 | 8 | — |
| 5 | 33 | — |
| 6 | 56 | — |
| 7 | 83 | 28 |
| 8 | 129 | 54 |
| 9 | 196 | 91 |
| 10 | 248 | 133 |
| 11 | 301 | 183 |
| 12 | 390 | 276 |
| 13 | 548 | 360 |
| 14 | 640 | 499 |
| 15 | 775 | 646 |
| 16 | 870 | 771 |
| 17 | 935 | 852 |
| 18 | 1100 | 962 |

Torque (Nmm)

TABLE 18
Torque (Nmm) for direction No. 2

| Speeds (m/s) | Rotor with torque wrench |
|---|---|
| 7 | 19 |
| 8 | 20 |
| 9 | 20 |
| 10 | 22 |
| 11 | 22 |
| 12 | 23 |
| 13 | 25 |
| 14 | 26 |
| 15 | 27 |
| 16 | 28 |
| 17 | 30 |
| 18 | 29 |

### Results for Direction No. 3

Angular Speeds (rpm)

TABLE 19
RPM for direction No. 3

| | | Rotor with |
|---|---|---|
| Speed (m/s) | Free rotor | torque wrench |
| 4 | 14 | — |
| 5 | 31 | — |
| 6 | 53 | — |
| 7 | 80 | 48 |
| 8 | 118 | 93 |
| 9 | 169 | 141 |
| 10 | 240 | 226 |
| 11 | 303 | 338 |
| 12 | 405 | 438 |
| 13 | 485 | 598 |
| 14 | 626 | 702 |
| 15 | 723 | 830 |
| 16 | 800 | 959 |
| 17 | 930 | 1093 |
| 18 | 1100 | 1243 |

### Torque (Nmm)

TABLE 20
Torque (Nmm) for direction No. 3

| Speeds (m/s) | Rotor with torque wrench |
|---|---|
| 7 | 18 |
| 8 | 19 |
| 9 | 21 |
| 10 | 22 |
| 11 | 23 |
| 12 | 25 |
| 13 | 27 |
| 14 | 27 |
| 15 | 29 |
| 16 | 29 |
| 17 | 30 |
| 18 | 31 |

Based on the above results, the power curve shown on the following table 21 was done.

### Final Conclusions:

As shown in all rpm tables above mentioned, and as expected, an increase in wind speed means increases in the rotor's rpm or torque or angular speed, in each case, and therefore an increase in power.

It is worth mentioning that the operation and performance of the turbine are directly related to its direction with respect to the prevailing wind direction, highlighting that direction No. 3 is the one showing best results in terms of power (this aspect should be considered when defining the location of the device).

If analyzed separately, rpm and torque variations allow drawing some conclusions. On the one hand, it is difficult to define a noticeable rpm value behavior pattern, since according to the tables, the best direction from the point of view of rpm, it changes depending on the fact if there is a load or torque or not (a load may affect the internal fluid dynamic field due to the interaction between the rotor speed and its geometry). On the other hand, from the point of view of torque, the results show that the best direction is No. 3.

Please note that the double rotor design for vertical axis turbine comprising two simple rotors with three vanes of equal height of this invention allows autonomous start speeds lower than those of the other rotors, i) and ii), as shown in Table 14. This is shown either if loaded or not.

A further comparative advantage of this model iii) with respect to the rotors i) and ii) is the noticeable reduction of noise emissions.

In comparison, it can be concluded that this rotor design achieved substantial improvements in start speeds due to the displacement between the two sections that make up the rotor. This allows a start less influenced by the position of the rotor vanes with respect to the direction of the wind.

The fluid dynamic model used determines the rotor behavior is also comparable regarding different types of fluids, such as liquid and semiliquid fluids.

### NUMERICAL REFERENCES

1: Double rotor comprising two single rotors with three vanes with equal height for vertical axis turbine.

### 2: Upper Rotor

### 3: Lower Rotor

### 4: Vane

### 5: Horizontal or Separation Plate

6: Hollow core
7: Covered hollow core
8: opening passed by the vertical axis of the turbine.

As a result of the above, it is understood that this invention covers the modifications and variations thereof as long as they are within the scope of the attached claims and their equivalents.

1. A double rotor for vertical axis turbine comprising two single rotors with three vanes with equal height, separated by a horizontal or separation plate, wherein such plate provides two different access areas for the propelling fluid and between each of the three vanes of each of the single rotors, there is surface continuity attenuated by curves in fluid flow direction preventing parasitic flows during rotor rotation.

2. The double rotor according to claim 1, wherein the two single three-vane rotors comprise the so-called upper rotor and lower rotor according to their relative spatial positions within such vertical axis turbine, having each rotor hollow cores.

3. The double rotor according to claim 3, wherein the hollow cores are covered below and above, leaving an opening through which the vertical axis of the turbine passes and such axis is joined to the upper and lower rotors.

4. The double rotor according to claim 3, wherein the upper rotor is separated from the lower rotor by means of the horizontal or separation plate which is joined to such rotors and passed by the vertical axis of the turbine.

5. The double rotor according to claim 4, wherein both the upper rotor and the lower rotor have their vanes separated by means of an angle of 120 degrees.

6. The double rotor according to claim 5, wherein each vane of the upper rotor is displaced with respect to each vane of the lower rotor by means of an angle of 60 degrees.

7. The double rotor according to claim 6, wherein each of the three vanes that make up each of the rotors, upper and lower, are arranged on the outside of a R radius circumference around the vertical axis which has an inner wall which makes up the hollow core of each single rotor.

8. The double rotor according to claim 7, wherein the farthest area from the vertical axis of each vane belonging to each rotor, upper and lower, during rotation, generates a 4R radius circumference equal to the radius of the horizontal or separation plate which separates such upper rotor from the lower rotor.

9. The double rotor according to claim 8, wherein each of the vanes that make up the upper and lower rotors have dolphin fin shape thus having an aerodynamic design profile like a plane wing, wherein such profile has a convex area in the extrados and a concave area in the intrados.

10. The double rotor according to claim 9, wherein both on the upper rotor and the lower rotor, the convex area in the extrados of one of the vanes joins with the concave area of the intrados of the next vane through a 0.5R radius circumference.

11. The double rotor according to claim 10, wherein the convex area in the extrados of each of the vanes corresponds to a portion of 5R radius circumference taken as center a first point on the 4R radius circumference generating the outermost portion of each vane when rotating around the vertical axis.

12. The double rotor according to claim 10, wherein the concave area in the intrados of each of the vanes corresponds to a portion of 4R radius circumference taken as center a second point on the 4R radius circumference generating the outermost portion of each vane when rotating around the vertical axis.

13. The double rotor according to claim 11, wherein the separation between the first point and the second point on the 4R radius circumference, generating the outermost portion of each vane when rotating around the vertical axis, is 1.20R.

14. The double rotor according to claim 12, wherein the separation between the first point and the second point on the 4R radius circumference, generating the outermost portion of each vane when rotating around the vertical axis, is 1.20R.
